(19) United States
(12) Patent Application Publication
(10) Pub. No.: US 2004/0234660 A1
(43) Pub. Date: Nov. 25, 2004

(54) Process for compression molding a dried aerated confection

(76) Inventors: Michael N. Bauman, Battle Creek, MI (US); Charles Gambino, Kalamazoo, MI (US); Chris Willoughby, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/844,989

(22) Filed: May 13, 2004

Related U.S. Application Data
(60) Provisional application No. 60/469,946, filed on May 13, 2003.

(51) Int. Cl. A01J 1/00

(52) U.S. Cl. 426/512

(57) ABSTRACT

A process is disclosed for forming a high definition three-dimensional aerated confection piece. The process comprises forming a dried aerated confection and then compression molding the confection to form the high definition piece. The process permits inclusion of a wide range of materials into the molded dried aerated confection. Preferably the process uses marbits, dehydrated marshmallows, or dried meringue. The molded pieces retain excellent buoyancy in liquids such as milk and hot cocoa mixes. Preferably the molded pieces are incorporated into ready to eat cereals, hot cocoa mixes, snacks and other food products.

### RELATED APPLICATIONS

This application claims the benefit of United States Provisional application number 60/469,946, filed May 13, 2003.

### STATEMENT REGARDING FEDERALLY SPONSORED RESEARCH

Not applicable.

### TECHNICAL FIELD

The subject invention relates generally to dried aerated confectionary products for use in foods and, more particularly, to compression molded dried aerated confections for use in food products.

### BACKGROUND OF THE INVENTION

There are principally two common dried aerated confections that are the subject of this invention. The first dried aerated confection is dried meringue commonly found in the past in the form of cookies or bars. The meringue on pies typically is not dried, but is formed from the same ingredients as the dried forms. Meringue is well known to be composed from egg whites and a sweetening agent such as sugar. Some formulations also include cream of tartar and/or flavoring agents like vanilla, or cocoa. Typically, the meringue is formed by combining all ingredients except for the sweetening agent and then beating the mixture until it is frothy. Once it has become frothy the sweetening agent is slowly with continued beating until stiff peaks are formed in the mixture. The mixture can then be formed into shapes and allowed to dry or baked to hasten the drying. For the present invention it is preferred that the meringue be dried to a moisture level of from 1 to 5%. Because of the delicate nature of the internal structure of undried meringue it is hard to form the meringue into any complex shapes.

A second dried aerated confection is a dried marshmallow, often found in Ready-to-Eat cereals and typically called a marbit in the industry. The broad idea of manufacturing marbits was disclosed in U.S. Pat. No. 2,847,311, issued to Doumak et al. on Aug. 12, 1958. The common method of forming marbits comprises an initial series of steps including: forming a mallow mixture, seeding the mallow mixture with a sugar while cooling it, and then mechanically aerating the mallow mixture to greatly reduce its density. The aerated mallow mixture can be further cooled if desired. Further additions of coloring agents or flavoring agents can be made to the mallow mixture. The aerated mallow mixture is then fed into an extruder and extruded through the die orifice in the form of a rope onto a moving bed conveyor. The moving bed conveyor typically includes a bed of a drying agent such as a drying starch, a dextrose, a glucose, a wax, or a sugar. Additional drying agent is deposited on top of the rope. After the rope has traveled on the conveyor for a sufficient period of time to setup or gel and to dry to some extent the rope is then transected by a cutting knife to form the marshmallow pieces. Generally, from 0.5 to 6 minutes is a sufficient period of time. Each piece has two opposite, parallel planar surfaces formed by the knife and an outer rim in the shape of the die orifice. The marshmallow pieces at this point have a moisture level of from about 10 to 30%. The marshmallow pieces are deposited onto a second conveyor as they are cut and here the cut ends are covered with drying agent from adjacent pieces. The cut pieces are conveyed to a dusting/dedusting drum which tumbles the pieces to ensure a uniform covering of drying agent and to remove the excess drying agent. Once the cut pieces are dedusted they are conveyed to a combination dryer and cooler unit and dried at a temperature of from 110 to 250° F. to a final moisture level of from 1 to 5%, thus forming a marbit.

The process described above produces a simple piece having two opposite, parallel, planar surfaces created by the knife and an outer rim in the shape of the die orifice. Thus, to date only flat marbit pieces having limited three dimensional aspects have been produced. The marbits include flat shaped pieces such as hearts, moons, and rainbows.

To date no extruded mallow mixture has been used to form complex three dimensional pieces. One difficulty is that the freshly extruded rope is extremely tacky but malleable. Any distortion to the shape of the rope during this stage is largely irreversible, but the high tackiness makes shaping the extrudate at this time very difficult. After roughly 30 seconds, dependant upon formulation, temperature, humidity, etc. the extrudate is noticeably less tacky and the texture has firmed to the point where it will spring back from a distortion, similar to a sponge, to its original form with little or no distortions. The firming of the texture and elastic memory of the extrudate is critical to the shaped rope retaining or regaining its form through the cutting and subsequent handling steps. There is considerable distortion to the desired rope shape during the cutting process, and the elastic memory of the mass is critical to the recovery of the desired shape.

The elastic memory of the mass is also the reason why repeated and widely varied experimentation to attempt to form a complicated three-dimensional design at this point in the marbit production process has resulted in consistent failure. Both continuous ropes of the firmed extrudate and freshly cut extrudate have been compressed into three-dimensional molds only to reveal two phenomenons. First, the mass is sufficiently malleable to initially assume the three-dimensional shape and then it immediately springs back to its original shape upon release of compression force due to its elastic memory. Second, even though the surface of the mass is coated in drying agent it is still sufficiently tacky, no moisture has been removed by drying at this point in the process, to quickly build-up and plug whatever compression molds are used. Hence, intricate three-dimensional shapes, which are more desirable, cannot be formed by this process.

Marbits, the dried marshmallows, are designed to be buoyant in milk and exhibit good bowl life in milk meaning they are slow to hydrate and soften, which makes them a very desirable additive for several types of Ready-to-Eat Cereals and hot cocoa mixes. Moreover, marbits have a light, airy delicate texture that is crystalline in nature and they can readily be pulverized to dust with the pressure of a person's fingertips.

One attempt at forming detailed three dimensional marbit pieces is disclosed in U.S. Pat. No. 6,376,003. The method set forth in the '003 patent includes creating and coloring a mallow mixture comprising sugar, water, protein, sodium bicarbonate, and monocalcium phosphate. The sodium bicarbonate and monocalcium phosphate provide a controlled chemical gassing for expanding the mallow mixture. Hence, a device for mechanically whipping to aerate the slurry is not required. In one embodiment the resulting mixture was extruded or shaped into a rope having a two-dimensional shape as discussed above. The sodium bicarbonate and monocalcium phosphate expand the rope to aerate the mixture. The rope is then cut and dried to define the chemically expanded marbit pieces.

The '003 patent also discloses an embodiment wherein the mallow mixture is rolled out into thin sheets and then the sheet is stamped with the desired images to form the pieces. The stamp may have a three-dimensional image. The sodium bicarbonate and monocalcium phosphate then expand the stamped pieces to aerate the pieces. Finally, the pieces are dried to define the chemically expanded marbit pieces. One deficiency with this process is that the three-dimensional stamped pieces become very distorted during the chemical expansion process so it is difficult to create a piece with good definition.

Accordingly, it would be desirable to develop a method that forms an intricate high definition three-dimensional dried aerated confection piece while not distorting any images formed within the piece.

### SUMMARY OF THE INVENTION

In one embodiment, the present invention is a method for compression molding a dried aerated confection comprising the steps of: providing at least one dried aerated confection piece having a plurality of air cells therein; and placing at least one of the dried aerated confection pieces into a compression mold and compression molding the at least one piece to form a molded piece while maintaining at least some of the air cells in the molded piece.

In a second embodiment, the present invention is a compression molded dried aerated confection having therein a plurality of air cells.

These and other features and advantages of this invention will become more apparent to those skilled in the art from the detailed description of a preferred embodiment. The drawings that accompany the detailed description are described below.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic diagram of a process for forming a marbit according to the present invention;

FIG. 2A is a perspective view of a marbit according to the present invention;

FIG. 2B is a perspective view of a marbit according to the present invention;

FIG. 2C is a perspective side view of the marbit of FIG. 2B;

FIG. 3 is a cross-sectional view of a compression molding apparatus for compressing a dried aerated confection according to the present invention;

FIG. 4 is a view of FIG. 3 as the compression is taking place;

FIG. 5 is a cross-sectional view of the compression molding apparatus of FIG. 3 containing a compression molded dried aerated confection;

FIG. 6 is a view of FIG. 5 showing ejection of the compression molded piece;

FIG. 7 is a perspective view of a sample three-dimensional compression molded dried aerated confection produced according to the present invention;

FIG. 8 is a cross-sectional view of a granulator for grinding dried aerated confection pieces for use according to the present invention;

FIG. 9 is a schematic view of a pile of ground pieces produced using the apparatus shown in FIG. 8;

FIG. 10 is a cross-sectional view of a compression molding apparatus for compressing ground dried aerated confection according to the present invention;

FIG. 11 is a view of FIG. 10 as the compression is taking place;

FIG. 12 is a cross-sectional view of the compression molding apparatus shown in FIG. 10 containing a compression molded dried aerated confection; and

FIG. 13 is a view of FIG. 12 showing ejection of the compression molded piece.

### DETAILED DESCRIPTION OF A PREFERED EMBODIMENT

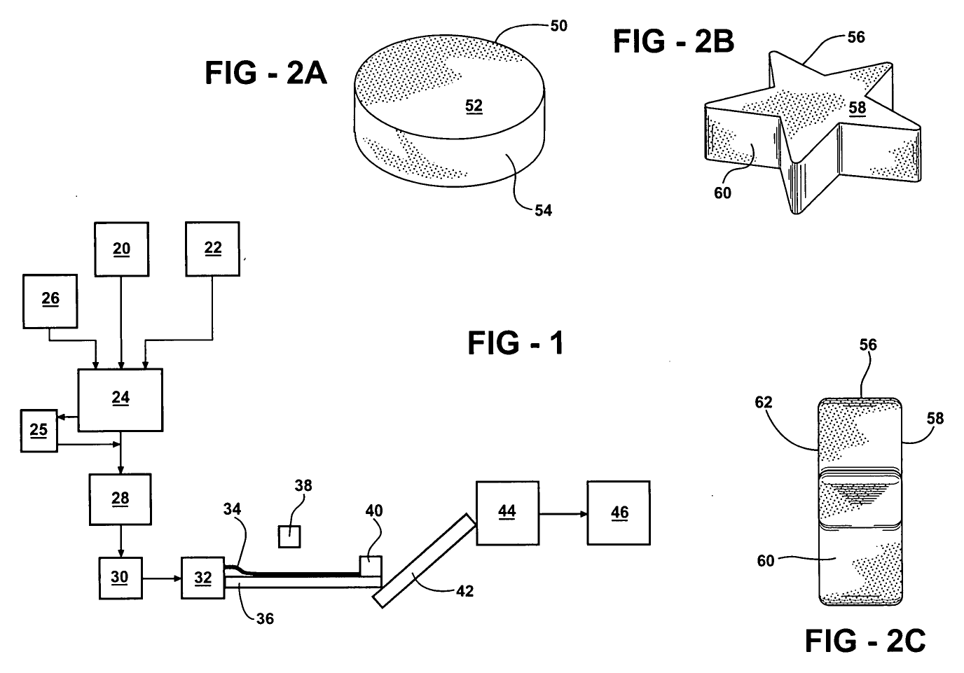

Referring to the Figures, wherein like numerals indicate like parts throughout the several views, in FIG. 1 a schematic diagram of a process for forming a marbit is shown generally at 10. In an initial step, a sucrose solution is prepared in a first tank 20. Tank 20 is thermally controlled and includes a mixer. The sucrose solution is prepared with water to have a solids level of from 82 to 89% and more preferably from 84 to 87%. In addition to sucrose the solution typically includes corn syrup, dextrose, or a mixture of corn syrup and dextrose. The sucrose solution can also be made without corn syrup, dextrose, or both, using instead maltose, lactose, glycerin, maltodextrin, a glucose syrup, or mixtures thereof. The components other than the sucrose are utilized to reduce the tendency for crystallization of the sucrose. In a preferred embodiment, the sucrose solution comprises sucrose, corn syrup, dextrose, and water. In such a sucrose solution there is preferably from 5.0% to 50.0% by weight of corn syrup, dextrose, substitutes for these noted above, or a combination thereof with the remainder comprising water and sucrose. In a typical preparation, the water, sucrose and corn syrup are initially mixed together and heated in first tank 20 to approximately 200° F. Once the sucrose has been hydrated the dextrose is added and the mixture is elevated to a temperature of from 243 to 246° F. with mixing to form the sucrose solution.

A second component is the formation of a film-forming solution in a second tank 22. Second tank 22 is thermally controlled and includes a mixer. A preferred film-forming agent is gelatin; however, other film-forming agents that could be utilized include proteins such as albumin, pectin, carboxymethyl cellulose, alginate, a gum, or mixtures of these film forming agents. Gums that are typically utilized include guar gum, carrageenan, arabic gum, and xanthan gum. The preferred film-forming agent in the present invention is a gelatin, either type A or type B. Two especially preferred gelatins are 225 and 250. When gelatin is the selected film-forming agent it is heated in water in the second tank 22 at approximately 170° F. to hydrate the film-forming agent and form the film-forming solution. When gelatin is utilized it is generally hydrated with water in a weight to weight ratio of 1:2; thus the solution is 33.33% gelatin and 66.67% water. The other film forming agents are also hydrated as known in the art. Typically at least 30 minutes are required for full hydration of the film-forming agent. Once hydrated, the film-forming solution is maintained at a temperature of from 150 to 165° F. in second tank 22.

The sucrose solution is then pumped into a third tank 24, which is also thermally controlled and includes mixing. The third tank 24 is initially set at a temperature of from 165 to 180° F. Preferably, the third tank 24 is initially set at a temperature of from 175 to 180° F. Once the sucrose solution is completely pumped into the third tank 24 it begins to cool to the initially set temperature. When the sucrose solution reaches a temperature of approximately 180° F. or below crystallization of the sucrose solution begins to occur at this its crystallization temperature. Once the sucrose solution has cooled to 180° F. additional components are added to the sucrose solution from a source tank 26 to form a mallow mix. For simplicity, only a single source tank 26 is shown, however, as would be understood by one of ordinary skill in the art numerous source tanks may be utilized, all feeding into third tank 24.

Once the sucrose solution reaches a temperature of 180° F., optionally, additives like fruit solids, flavors, colors, and a colloidal solution of hexametaphosphate are added from a source tank 26 to the mallow mix. Preferably, the fruit solids are added in the form of a dry fruit powder, but wet fruit solids can also be added provided they have a very high solids content of at least 80%. Preferably, the amount of fruit solids on a dry weight basis based on the final weight of the mallow mix comprises from 0.5 to 20.0%, more preferably from 0.5 to 10.0%, and most preferably from 2.0 to 5.0% by weight. The fruit solids can be prepared by a number of known techniques including: drum dried fruit, spray dried fruit, freeze dried fruit, or evaporated fruit puree at a high solids of over 80%. The fruit solids added to third tank 24 can comprise a mixture of any combination of fruit solids that is desired. It is important to add the fruit solids at this point in the procedure. To maintain the nutritional content of the fruit solids it is important that they not be exposed to high temperatures of generally greater than 180° F.

Flavor and colors are preferably added in amounts of from 0.1 to 3.0% by weight. The preferred hexametaphosphate is the sodium salt, although the potassium salt can also be utilized. The hexametaphosphate is preferably added in an amount of from 0.01 to 0.2% and more preferably from 0.02 to 0.05% by weight. The hexametaphosphate is important to allow the film-forming solution to firmly gel the final mallow mix to enable formation of an extrudable mass that can be cut into discrete pieces, as described below.

At the same time the optional components from tank 26 are added to third tank 24, a seed sugar in an amount of from 1.0 to 20.0% on a dry weight basis based on the total mallow mix weight is added to the mallow mix. Seed sugars ranked in increasing grain size that are useful in the present invention include: 10X powdered sugar; 6X powdered sugar; Bakers Special sugar; fruit sugar; extra fine granulated sugar; fine granulated sugar; and mixtures thereof. Any of these seed sugars alone or in combination is suitable. The type of sugar used depends on the desired texture of the final piece with finer grades of sugar producing a finer less gritty final piece. Especially preferred is a powdered sugar sized to 5% on a 100 United States Standard (USS) mesh screen and 80% thru a 200 USS mesh screen. Also especially preferred is a Bakers Special Sugar sized to 2% on a 50 USS mesh screen and 5% thru a 200 USS mesh screen. The mallow mix with the added seed sugar and other optional ingredients from tank 26 continues to be cooled and mixed until the temperature reaches approximately 165° F. Once the mallow mix reaches a temperature of 160° F., the film-forming solution from the second tank 22 is added to third tank 24. The film-forming solution is added in sufficient amount to provide an amount of preferably from 0.5 to 15.0% by weight on a dry weight basis of the film forming agent or agents based on the total weight of the mallow mix. More preferably the film forming agent or agents are present in an amount of from 1.0 to 7.0% by weight on a dry weight basis based on the total weight of the mallow mix.

The mallow mix is mixed and cooled until it reaches a temperature of approximately 145° F. The preferred density of the mallow mix is from 11.0 to 12.0 pounds per gallon with a moisture level of from 10 to 30% at this point in the procedure. If the fruit solids are added as a wet solids solution the contents of third tank 24 can be passed through an evaporator 25 such as a rotary evaporator, or microfilm cooker or other rapid evaporator to bring the final solids back to a range of from 82 to 86%.

In a next step the mallow mix formed in third tank 24 is pumped into a mechanical aerator 28. The aerator 28 is any of a commonly known variety such as Mondo Mixer™ or an Oakes™-type aerator. The aerator 28 is thermally controlled to a temperature range of from 125 to 165° F. The mallow mix is aerated to a density of from 1.5 to 4.0 pounds per gallon and more preferably from 2.0 to 3.0 pounds per gallon. The aerated mallow mix is then pumped from aerator 28 through a thermally controlled tube 30. The aerated mallow mix is preferably cooled to a temperature range of from 90 to 170° F., more preferably to a temperature of from 115 to 145° F., and most preferably to a temperature of from 125 to 135° F. The chilled, aerated mallow mix is then pumped to an extruder 32 and extruded into a rope 34 having any of a plurality of outer rim shapes. The extruded rope 34 exits the extruder 32 onto a moving bed conveyor 36 coated with a non-stick coating such as a dextrose, a glucose, a dusting starch, a sugar, or a wax. These non-stick coatings prevent the rope 34 from sticking to the conveyor 36. Additional non-stick coating is deposited onto the top of the rope 34 by a duster 38. The extruded rope 34 is preferably conveyed from the extruder 32 to a cutter 40 over a time period of from 0.5 to 6 minutes. When the rope 34 reaches the cutter 40 it is cut into appropriate sized pieces, which drop onto a second moving bed conveyor 42 where the cut ends are coated with the non-stick coating from adjacent cut pieces. The cut pieces are then conveyed via conveyor 42 to either a combination dusting and de-dusting drum 44 or through two separate drums comprising a first one for dusting and a second one for de-dusting to remove excess non-stick coating. The two drum embodiment is not shown. The drum 44 tumbles the pieces to accomplish the dusting and the dedusting. Once the cut pieces are de-dusted they are conveyed to a combination dryer and cooler unit 46 and dried at a temperature of from 110 to 250° F., and more preferably from 110 to 160° F., to a final moisture of from 1 to 5%, and more preferably from 2 to 3%, thus forming a marbit.

The hexametaphosphate colloidal solution has been found to be very advantageous in permitting the film-forming solution to sufficiently gel the mallow mix and rope 34 such that it can be cut by cutter 40 in a reasonable time frame. In the absence of hexametaphosphate the rope 34 takes a much longer time to firm and can not be cut uniformly by cutter 40 unless the moving bed conveyor 36 is made very long.

### EXAMPLE 1

Utilizing the general procedure described above marbits can be prepared using the solutions described below following the procedure as above. The sucrose solution is prepared per Table 1 below by combining the water, sucrose, and corn syrup in first tank 20 at a temperature of 200° F. The dextrose is then added and the mixture heated to a temperature of from 243 to 246° F.

TABLE 1

| Component | Kilograms | Percent by Weight |
|---|---|---|
| Sucrose | 81.72 | 65.72 |
| 42 DE Corn Syrup | 15.39 | 12.38 |
| Water | 14.44 | 11.61 |
| Dextrose | 12.8 | 10.29 |
| Total | 124.35 | 100.00 |

The film-forming solution is prepared in second tank 22 utilizing the components described in Table 2 below. The gelatin is heated to 170° F. for at least 30 minutes prior to use and maintained at a temperature of from 150 to 165° F.

TABLE 2

| Component | Kilograms | Percent by Weight |
|---|---|---|
| Gelatin | 2.59 | 33.33 |
| Water | 5.18 | 66.67 |
| Total | 7.77 | 100.00 |

To form the mallow mix the sucrose solution from first tank 20 is pumped into third tank 24 and cooled to 180° F. Then the fruit solids and seed sugar, powdered sugar, are added to third tank 24. The mallow mixture is then cooled to 165° F. at which point the gelatin solution, flavor, color, and colloidal suspension of hexametaphosphate are added. The hexametaphosphate is made up in the water noted in Table 3 below. The components added to third tank 24 are as noted below in Table 3.

TABLE 3

| | | Percent |
|---|---|---|
| Component | Kilograms | by Weight |
| Sucrose Solution | 121.5 | 89.22 |
| Gelatin Solution | 7.77 | 5.7 |
| Powdered Sugar (seed sugar) | 2.32 | 1.7 |
| Fruit Solids | 3.27 | 2.4 |
| Flavor | 0.572 | 0.42 |
| Liquid Color | 0.594 | 0.44 |
| Sodium Hexametaphosphate | 0.027 | 0.02 |
| Water | 0.136 | 0.10 |
| Total | 136.23 | 100.00 |

The formed mallow mix is then pumped through aerator 28 to produce a density of 2.2 pounds per gallon. The aerated solution is pumped through a thermally controlled tube 30 and chilled to 125° F. The chilled solution is then extruded through extruder 32 with final treatment being as described above under the general procedure.

### EXAMPLE 2

Utilizing the general procedure described above Kosher marbits can be prepared using the solutions described below following the procedure as above. The sucrose solution is prepared per Table 4 below by combining the water, sucrose, and corn syrup in first tank 20 at a temperature of 200° F. The dextrose is then added and the mixture is heated to a temperature of from 243 to 246° F.

TABLE 4

| Component | Kilograms | Percent by Weight |
|---|---|---|
| Sucrose | 81.72 | 65.69 |
| 64 DE Corn Syrup | 15.44 | 12.41 |
| Water | 14.53 | 11.68 |
| Dextrose | 12.71 | 10.22 |
| Total | 124.40 | 100.00 |

The film-forming solution used is egg albumen hydrated in cold water, strained, and added to tank 22 utilizing the components described in Table 5 below.

TABLE 5

| Component | Kilograms | Percent by Weight |
|---|---|---|
| Egg Albumen | 5.45 | 33.33 |
| Water | 10.90 | 66.67 |
| Total | 16.34 | 100.00 |

To form the mallow mix the sucrose solution from first tank 20 is pumped into third tank 24 and cooled to 180° F. Then the fruit solids and seed sugar, powdered sugar, are added to third tank 24. The mallow mixture is then cooled to 140° F. at which point the albumen solution, flavor, and solution of hexametaphosphate are added. The hexametaphosphate is made up in the water noted in Table 6 below. The components added to third tank 24 are as noted below in Table 6

TABLE 6

| | | Percent |
|---|---|---|
| Component | Kilograms | by Weight |
| Sucrose Solution | 122.2 | 84.53 |
| Albumen Solution | 16.34 | 11.31 |
| Powdered Sugar (seed sugar) | 2.32 | 1.60 |
| Fruit Solids | 3.27 | 2.26 |
| Flavor | 0.272 | .19 |
| Sodium Hexametaphosphate | 0.027 | .019 |
| Water | 0.136 | 0.09 |
| Total | 136.23 | 100.00 |

The formed mallow mix is then pumped through aerator 28 to produce a density of 2.2 pounds per gallon. The aerated solution is pumped through a thermally controlled tube 30 and chilled to 125° F. The chilled solution is then extruded through extruder 32 with final treatment being as described above under the general procedure.

### EXAMPLE 3

Formulations for making meringue are well known in the art. In general the following formulation can be used and scaled up as needed. Beat 3 egg whites until frothy. The egg whites can optionally be beaten in the presence of ¼ to ½ a teaspoon of cream of tarter. Slowly add 6 tablespoons of sweetener, preferably sugar, while continuing to beat the egg whites until stiff peaks form. Shape the meringue and then dry at elevated temperature of from 110 to 250° F. until the moisture is reduced to from 1 to 5%. Other optional ingredients that can be included are natural and artificial flavorings, natural and artificial coloring agents, cocoa, chocolate, and salt. The ratio of sweetener to egg white can be varied widely as is known in the art depending on the desired sweetness and texture of the final product. In making the meringue one can also use dried egg whites. In one formulation 6% by weight based on the final formulation weight of dry egg whites are combined with 12% by weight based on the final formulation weight of water. The mixture is allowed to soak for 5 to 15 minutes and then it is remixed. To the remixed egg and water mixture is added, all based on final formulation weight, 0.25% salt, 0.05% citric acid, 40% granulated sugar, and 11% additional water. This combination is whipped for 2 minutes or until aerated and then 30.7% by weight of 6X powdered sugar is added with continued mixing to form the meringue. In another formulation 4% by weight of dry egg whites is combined with 8% by weight of water and allowed to soak for 5 to 15 minutes and then remixed. To the remixed egg and water mixture is added 0.2% by weight salt, 0.05% by weight citric acid, 40% by weight granulated sugar, 3% by weight 42 DE corn syrup, and 13% by weight water. This combination is whipped for 2 minutes or until aerated and then 31.75% by weight of 6X powdered sugar is added with continued mixing to form the meringue.

FIGS. 2A through 2C are perspective views of marbits produced according to the present invention. In FIG. 2A a disc-shaped marbit is shown at 50. The marbit 50 includes a first planar side 52 that is opposite a second planar and parallel side, not shown. The marbit 50 includes an outer rim 54 in the shape of the die orifice used to form it. In FIGS. 2B and 2C a star-shaped marbit is shown at 56. The marbit 56 includes a first planar side 58 opposite and parallel to a second planar side 62. The marbit 56 has a star-shaped outer rim 60. The first and second planar sides 52, 58 and 62 are formed by the cutter 40. The shapes shown in FIGS. 2A through 2C could also be obtained by shaping a meringue as described above.

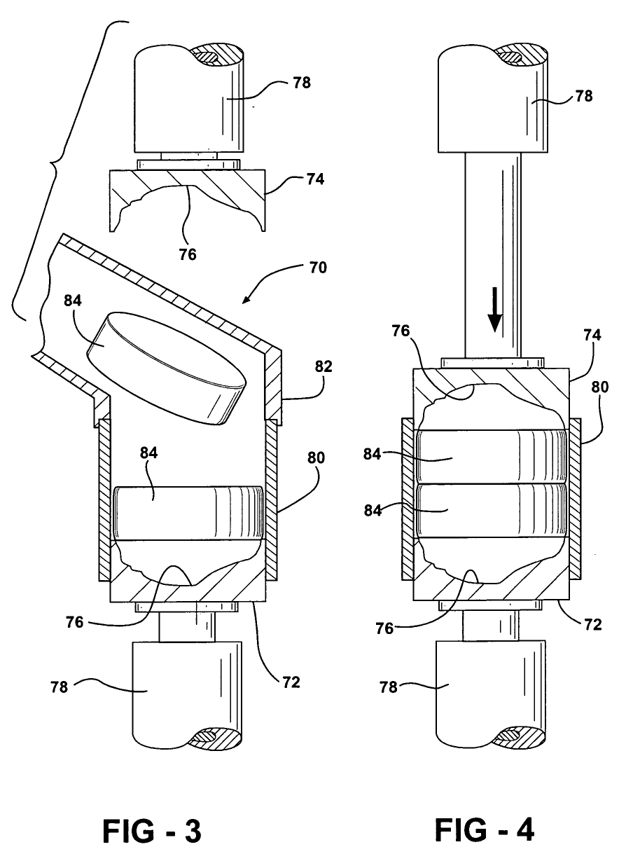

In one embodiment of the present invention one or more whole aerated confection pieces, be they marbit pieces or meringue pieces, are formed into a desired three-dimensional shape using a compression molding apparatus. This embodiment is shown in FIGS. 3 through 7 and described below.

To maintain the buoyancy of a compression molded dried aerated confection in a liquid it is important that the starting material not be compressed more than approximately 50%. Preferably the starting piece is compressed from 10 to 50% in the compression molding process. This level of compression ensures that a sufficient number and volume of the trapped air cells formed during aeration of the confection are maintained in the molded product. In general, the median cross-sectional size of the air cells in the dried aerated confections of the present invention is less than 100 microns. The actual volume of air cells needed for buoyancy in a given liquid depends on the shape of the compressed piece. For example spherical pieces need more trapped air cells to remain buoyant than do flatter more disc-shaped pieces.

In FIGS. 3 through 6 a compression molding apparatus is shown schematically at 70 during several stages of operation. This apparatus 70 can be a typical tableting machine such as a Stokes or a Natoli Tableting Machine model BB Type Tablet Press as is known in the art. The apparatus 70 includes a lower mold half 72 and an upper mold half 74. Each mold half 72, 74 includes an inner surface 76 having the desired three dimensional shape. Each half 72, 74 is supported by a piston 78 which is extendable and retractable. A portion of the lower mold half 72 is surrounded by a retainer cylinder 80 that extends above the lower mold half 72. The retainer cylinder 80 has a shape that matches the outer perimeter 92 of the molded piece 86 produced by the mold halves 72, 74. In FIG. 3 the apparatus 70 is shown in a first or loading position. In this position a chute 82 is received adjacent the cylinder 80 and serves to guide one or more whole dried aerated confection pieces 84 into the cylinder 80 and the cylinder 80 ensures that the dried aerated confections piece(s) 84 are properly oriented above and resting on the lower mold half 72. The piston 78 supporting the upper mold half 74 is in a fully retracted position. Preferably, the dried aerated confection piece(s) 84 have a thickness that is 10 to 50% greater than the deepest depth of the lower mold half 72. It has been found that the dried aerated confection pieces 84 can readily be compressed from above and below and will conform to the shape of the mold halves 72. 74, however, the piece(s) do not readily flow sideways in the mold halves 72 and 74 during compression.

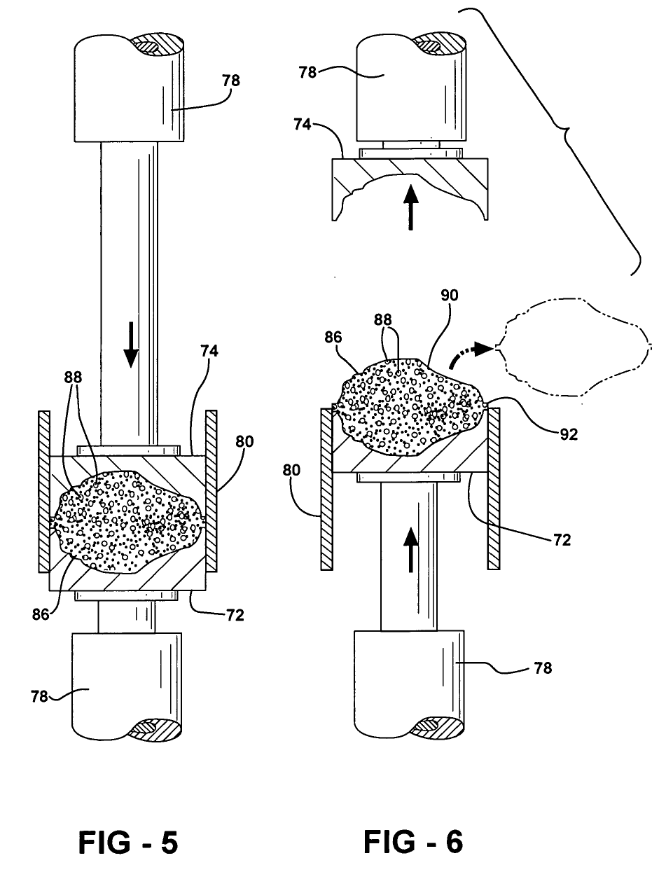

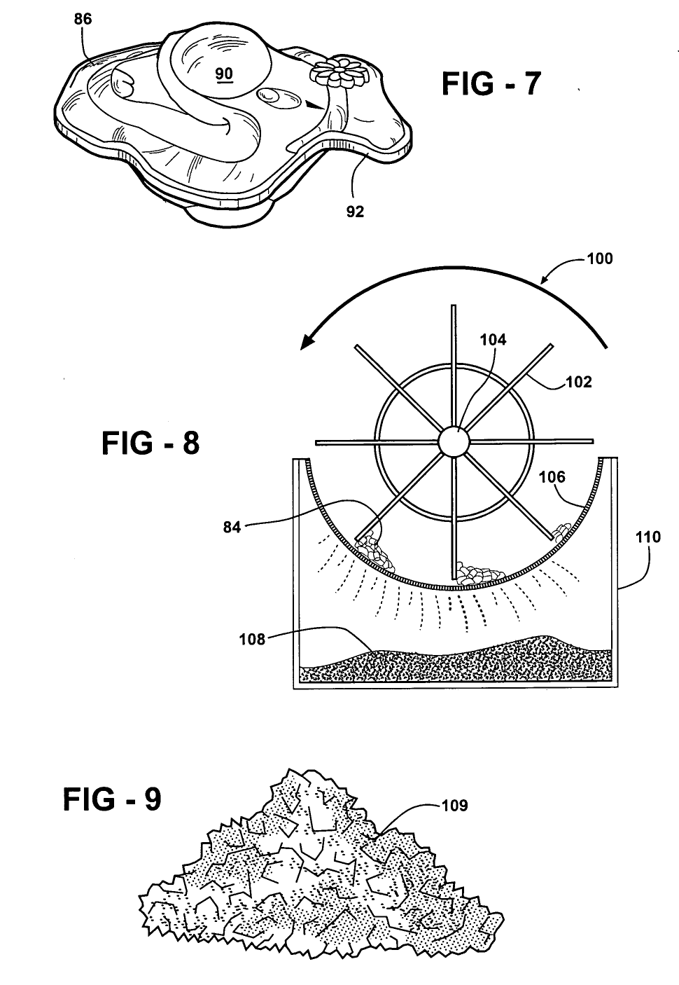

In FIG. 4 the apparatus 70 is shown in the pre-compression position. In this position the chute 82 has been moved away from the cylinder 80 and the piston 78 supporting the upper mold half 74 has been partially extended. The upper mold half 74 is received within the cylinder 80. In FIG. 5 the apparatus 70 is shown in the full compression position. Here the piston 78 supporting the upper mold half 74 is fully extended. Note the halves 72 and 74 do not touch each other even in the full compression position, this is important to preserve the structural integrity of the halves 72 and 74 with repeated use. In the full compression position the dried aerated confection piece(s) 84 are transformed into a compression molded piece 86. Note that because the compression of the starting piece 84 is only 10 to 50% molded piece 86 still retains a significant number of air cells 88. The molded piece 86 has an outer surface 90 that mirrors the shape of the surface 76 and an outer perimeter 92 formed between the halves 72 and 74 when the apparatus 70 is in the full compression position. In FIG. 6 the apparatus 70 is shown in the ejection position. Here the upper mold half 74 is retracted from the cylinder 80 and the piston 78 of lower mold half 72 is extended to eject the molded piece 86. FIG. 7 is a perspective view of one example of the compression molded piece 86. Obviously the piece 86 can assume any shape that is formed by the combination of the halves 72 and 74. The piece in FIG. 7 is merely illustrative of the sort of complex three-dimensional shapes that can be created by the present process. In this embodiment the pieces 84 can have different colors, flavors, or textures to create a molded piece 86 having a combination of colors, flavors or textures. If the interior surfaces 76 of the two halves 72 and 74 have different shapes then a two surfaced molded piece 86 can be created. For example one half 72 could form a front view of a face and the other half 74 could form a back of the head view of a face. Likewise a plurality of whole pieces 84 could be used to create unique colors, tastes, or textures in the molded piece 86. Surprisingly, it has been found that the present process can mold a multiple of pieces 84 into a single unitary whole without issues of separation of the molded piece 86 into the initial pieces 84.

In another embodiment it has been discovered that the dried aerated confection pieces 84 can be ground before the compression molding process. This provides several advantages. First, the more finely ground the pieces 84 the higher the resolution of any three-dimensional molded piece 86. Starting with a ground piece 84 makes it easy to incorporate additives into the compression molded piece 86. Preferably, these additives are also powders having a particle size similar to that of the ground pieces 108. The additives can include things such as: vitamins, dyes, flavors, fillers, medicines, fruit powder, flours, cereals, edible lubricants, emulsifiers, anti-caking agents, protein, fiber, and cookie pieces. This embodiment is shown in FIGS. 8 through 13.

There are many ways to grind the dried aerated confection pieces 84 and one schematic of a granulator apparatus is shown in FIG. 8 at 100. The apparatus 100 includes a plurality of paddles 102 that rotate about a spindle 104 and pass pieces 84 across a grinding screen 106. The ground pieces 108 pass through the screen 106 into a hopper 110. In addition to using a granulator apparatus 100 one could pulverize, break, or otherwise reduce the size of the pieces 84 by many other methods known in the art. The ground pieces 108 and any other additives, as described above, are then sized using a common sieving apparatus by sieving through a number 3 USS and onto a number 30 USS, and more preferably through a number 12 USS and onto a number 24 USS. The number 3 sieve has openings of 6730 microns, the number 12 has openings of 1680 microns, the number 24 sieve has openings of approximately 710 microns, and the number 30 has openings of 595 microns. What is important is that the dried aerated confection pieces 84 not be ground so fine that they lose all of their air cells. As discussed above the median cross-sectional size of the air cells is less than 100 microns. The components are then mixed together to form a compression powder 109.

Vitamins and minerals such as calcium can be added into the compression powder as discussed above. Dyes can be added to form the powder 109 at 0 to 2% by weight based on the total weight of the powder 109 and more preferably at 0.01 to 2%. One advantage to use of powdered dyes is the molded piece 86 can be made white or colorless and it will change to the dye color once the molded piece 86 is exposed to a liquid such as milk. Flavors are also added at 0 to 2% by weight based on the weight of the powder 109 and more preferably at 0.01 to 2% by weight. Useful fillers include: tableting starches, dextrose and malto-dextrin combinations such as Royal T® brand, other tableting sugars, dextrose, malto-dextrin, dextrin, and mixtures thereof. The filler is preferably used at 0 to 30% by weight based on the weight of the powder 109, more preferably at 10 to 30% by weight. The fruit powder used can be freeze dried fruit, spray dried, drum dried or ground fruit, and preferably it is used at a level of from 0 to 15% by weight based on the weight of the powder 109 and more preferably at 5 to 15% by weight. Many types of flour can be used including nut flours such as peanut flour and other nut flours. Preferably the flour is used at 0 to 20% by weight based on the weight of the powder and more preferably at 5 to 20% by weight. The flours can also provide a significant level of protein to the molded piece 86. Useful cereals include ready to eat cereals such0 as Kellogg's All-Bran® cereal as well as cereal grains. Preferably the cereal is used in an amount of from 0 to 50% by weight based on the weight of the powder 109, more preferably at 10 to 50% by weight. Edible lubricants, emulsifiers and anti-caking agents that have been found useful include magnesium stearate, mono-glycerides, di-glycerides, and tricalcium phosphate. Preferably one or more of these components are each present in an amount of from 1 to 2% by weight based on the weight of the powder 109. Magnesium stearate has been found to be especially useful as a lubricant. The amount of protein that can be added is not limited by the process; very high levels can be included. The main limiting factor for incorporation of protein using currently available source of protein is the adverse organoleptic effect of very high levels of protein. Useful source of protein include: whey protein, whey protein isolates, soy protein, soy protein isolates, textured soy protein, wheat gluten, textured vegetable protein, and cheese powders. Palatable molded pieces 86 can be made with from 0 to 20% by weight protein and more preferably from 2 to 20% by weight protein based on the weight of the powder 109. Fiber in addition to that found in the cereals can also be added to the powder 109. Sources of fiber include inulin and psyllium. Preferably the fiber is added in amounts of from 0 to 50% by weight and more preferably from 2 to 50% by weight based on the total weight of the powder 109. Cookie pieces can comprise from 0 to 20% by weight based on the weight of 109 and more preferably from 10 to 20% by weight. The remainder of the powder 109 is comprised of the sieved ground dried aerated confection pieces 108.

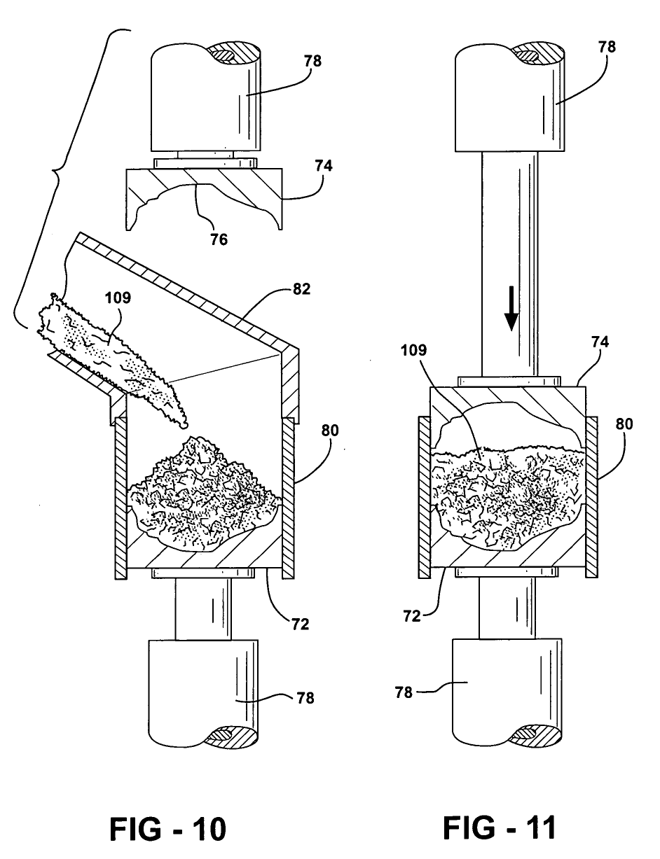

In FIGS. 10 through 13 a compression molding apparatus is shown schematically at 70 during several stages of operation. This apparatus 70 can be a typical tableting machine as is known in the art. The apparatus 70 includes a lower mold half 72 and an upper mold half 74. Each mold half 72, 74 includes an inner surface 76 having the desired three dimensional shape. Each half 72, 74 is supported by a piston 78 which is extendable and retractable. A portion of the lower mold half 72 is surrounded by a retainer cylinder 80 that extends above the lower mold half 72. In FIG. 10 the apparatus 70 is shown in a first or loading position. In this position a chute 82 is received adjacent the cylinder 80 and serves to guide the powder 109 into the cylinder 80 and the cylinder 80 ensures that the powder 109 fills and over flows the lower mold half 72. The piston 78 supporting the upper mold half 74 is in a fully retracted position. Preferably, the powder 109 has a thickness that is 10 to 50% greater than the widest dimension of the finished molded piece 86. It has been found that the powder 109 can readily be compressed from above and below and will conform to the shape of the mold halves 72. 74, however, the powder 109 does not readily flow sideways in the mold halves 72 and 74 during compression.

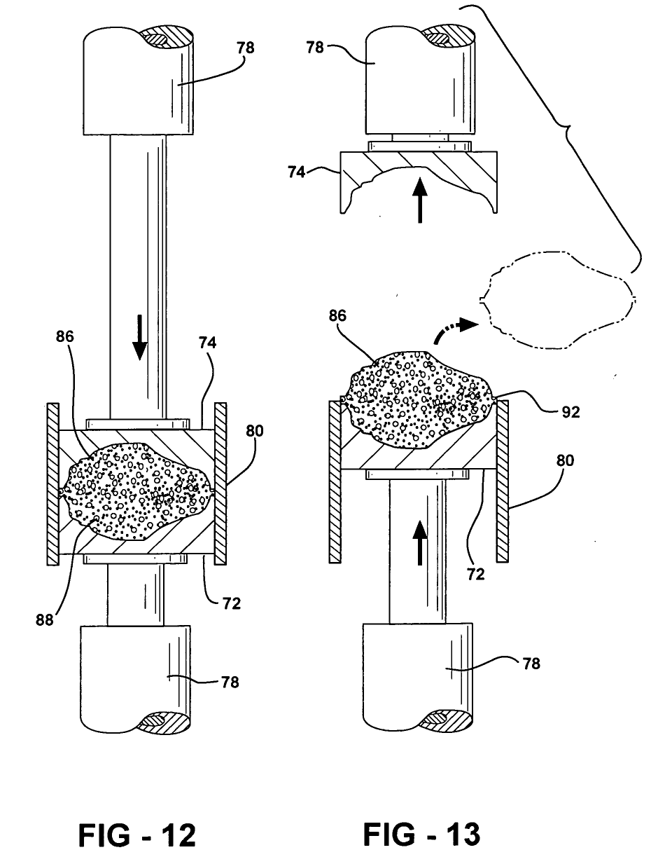

In FIG. 11 the apparatus 70 is shown in the pre-compression position. In this position the chute 82 has been moved away from the cylinder 80 and the piston 78 supporting the upper mold half 74 has been partially extended. The upper mold half 74 is received within the cylinder 80. In FIG. 12 the apparatus 70 is shown in the full compression position. Here the piston 78 supporting the upper mold half 74 is fully extended. Note the halves 72 and 74 do not touch each other even in the full compression position, this is important to preserve the structural integrity of the halves 72 and 74 with repeated use. In the full compression position the powder 109 is transformed into a compression molded piece 86. Note that because the compression of the starting powder 109 is only 10 to 50% the molded piece 86 still retains a significant number of air cells 88. The molded piece 86 has an outer surface 90 that mirrors the shape of the surface 76 and an outer lip 92 formed between the halves 72 and 74 when the apparatus 70 is in the full compression position. In FIG. 13 the apparatus 70 is shown in the ejection position. Here the upper mold half 74 is retracted from the cylinder 80 and the piston 78 of lower mold half 72 is extended to eject the molded piece 86. If the interior surfaces 76 of the two halves 72 and 74 have different shapes then a two surfaced molded piece 86 can be created. For example one half 72 could form a front view of a face and the other half 74 could form a back of the head view of a face.

### EXAMPLE 4

In this example 73 grams of sieved marbit was combined with 25 grams of dextrose, 1.5 grams of magnesium stearate, 1 gram of flavors, 0.1 gram of blue number 2 dye and 1 gram of red number 3 dye. The formed powder 109 was then compression molded as described above.

### EXAMPLE 5

In this example 84 grams of sieved marbit was combined with 1 gram of magnesium stearate and 15 grams of 14% fat peanut flour. The formed powder 109 was compression molded as described above.

For both compression molding processes described above it is important that the room humidity be lower than about 55% and more preferably less than 40%. Higher humidity leads to problems with flow of the pieces 84 and powder 109 and also to sticking of the molded piece 86 in the mold halves 72 and 74. Another factor is the temperature of the mold halves 72, 74 preferably they are kept at from 50 to 120° F. and more preferably from 70 to 90° F. This reduces sticking to the mold halves 72, 74.

In one preferred use, the molded pieces 86 are combined with Ready-to-Eat cereal pieces to create a wholesome and nutritious cereal. The pieces 86 will float in milk, which is typically added to the cereal. The three-dimensional nature of the piece 86 improves the visual appeal to the consumers, and in particular to children. The molded piece 86 is surprisingly robust and can be packaged using the standard food packaging techniques in the industry while still maintaining structural integrity despite being a dried aerated confection.

The processing technique for producing molded piece 86 is uniquely suited for incorporating temperature and/or moisture sensitive ingredients such as Vitamin C into the piece 86. Aerated confections are normally, though not exclusively; fat free which makes the molded piece 86 an ideal carrier for reactive forms of essential minerals such as bioavailable forms of iron. Moreover, with the sweet, pleasant flavor of a dried aerated confection, the molded piece is an ideal carrier and masking agent for slurry of medicinal substances or vitamins. As such, the final molded piece can be a tablet or pill taken by a consumer as medicine or as a vitamin supplement. Other uses include use of the piece in hot cocoa mixes or in snacking mixes. The many varied formulations for the piece 84 and the powder 109 allow the final molded piece 86 to readily find use in a wide variety of foods.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method for compression molding a dried aerated confection comprising the steps of:
a) providing at least one dried aerated confection piece having a plurality of air cells therein; and
b) placing at least one of said dried aerated confection pieces into a compression mold and compression molding said at least one piece to form a molded piece while maintaining at least some of said air cells in said molded piece.

2. The method of claim 1 comprising in step a) providing at least one dried aerated confection piece having a moisture level of from 1 to 5%.

3. The method of claim 1 comprising in step a) providing as said at least one dried aerated confection piece a dehydrated marshmallow or a dried meringue.

4. The method of claim 1 comprising in step a) providing a plurality of dried aerated confection pieces and in step b) placing a plurality of said pieces into said compression mold and compression molding said pieces to form said molded piece.

5. The method as recited in claim 1 comprising in step a) providing at least a first dried aerated confection piece and at least a second dried aerated confection piece wherein said first and said second piece differ from each other in at least one of flavor, color, or formulation and in step b) placing said first and said second pieces into said compression mold and compression molding said first and said second pieces to form said molded piece.

6. The method as recited in claim 1 wherein step a) comprises providing a plurality of dried aerated confection pieces each having a size of from 6730 microns to 595 microns and step b) comprises placing a plurality of said pieces into said mold and compression molding said pieces to form said molded piece.

7. The method as recited in claim 1 wherein step a) comprises providing a plurality of dried aerated confection pieces each having a size of from 1680 microns to 700 microns and step b) comprises placing a plurality of said pieces into said mold and compression molding said pieces to form said molded piece.

8. The method as recited in claim 6 further comprising in step a) mixing said plurality of pieces with a vitamin, or a mineral, or a mixture thereof to form a compression powder and step b) comprises placing said compression powder into said mold and compression molding said powder to form said molded piece.

9. The method as recited in claim 6 further comprising in step a) mixing said plurality of pieces with a dye to form a compression powder and step b) comprises placing said compression powder into said mold and compression molding said powder to form said molded piece.

10. The method as recited in claim 9 comprising providing said dye in an amount of from 0.01 to 2% by weight based on the total weight of said compression powder.

11. The method as recited in claim 6 further comprising in step a) mixing said plurality of pieces with a flavor to form a compression powder and step b) comprises placing said compression powder into said mold and compression molding said powder to form said molded piece.

12. The method as recited in claim 11 comprising providing said flavor in an amount of from 0.01 to 2% by weight based on the total weight of said compression powder.

13. The method as recited in claim 6 further comprising in step a) mixing said plurality of pieces with a filler to form a compression powder and step b) comprises placing said compression powder into said mold and compression molding said powder to form said molded piece.

14. The method as recited in claim 13 comprising providing said filler in an amount of from 10 to 30% by weight based on the total weight of said compression powder.

15. The method as recited in claim 13 comprising providing dextrose as said filler.

16. The method as recited in claim 6 further comprising in step a) mixing said plurality of pieces with a fruit powder to form a compression powder and step b) comprises placing said compression powder into said mold and compression molding said powder to form said molded piece.

17. The method as recited in claim 16 comprising providing said fruit powder in an amount of from 5 to 15% by weight based on the total weight of said compression powder.

18. The method as recited in claim 16 comprising providing at least one of a freeze dried fruit, a spray dried fruit, a drum dried fruit, a ground fruit, or a mixture thereof as said fruit powder.

19. The method as recited in claim 6 further comprising in step a) mixing said plurality of pieces with a flour to form a compression powder and step b) comprises placing said compression powder into said mold and compression molding said powder to form said molded piece.

20. The method as recited in claim 19 comprising providing said flour in an amount of from 5 to 20% by weight based on the total weight of said compression powder.

21. The method as recited in claim 6 further comprising in step a) mixing said plurality of pieces with a cereal to form a compression powder and step b) comprises placing said compression powder into said mold and compression molding said powder to form said molded piece.

22. The method as recited in claim 21 comprising providing said cereal in an amount of from 10 to 50% by weight based on the total weight of said compression powder.

23. The method as recited in claim 21 comprising providing at least one of a ready to eat cereal, a cereal grain, or a mixture thereof as said cereal.

24. The method as recited in claim 6 further comprising in step a) mixing said plurality of pieces with at least one of an edible lubricant, an emulsifier, an anti-caking agent, or a mixture thereof to form a compression powder and step b) comprises placing said compression powder into said mold and compression molding said powder to form said molded piece.

25. The method as recited in claim 24 comprising providing at least one of an edible lubricant, an emulsifier, or an anti-caking agent in an amount of from 0.5 to 2% by weight based on the total weight of said compression powder.

26. The method as recited in claim 6 further comprising in step a) forming a compression powder by mixing said plurality of pieces with 0.5 to 2% by weight of magnesium stearate based on the total weight of said compression powder and step b) comprises placing said compression powder into said mold and compression molding said powder to form said molded piece.

27. The method as recited in claim 6 further comprising in step a) mixing said plurality of pieces with cookie pieces to form a compression powder and step b) comprises placing said compression powder into said mold and compression molding said powder to form said molded piece.

28. The method as recited in claim 27 comprising providing said cookie pieces in an amount of from 10 to 20% by weight based on the total weight of said compression powder.

29. The method as recited in claim 6 further comprising in step a) mixing said plurality of pieces with a protein to form a compression powder and step b) comprises placing said compression powder into said mold and compression molding said powder to form said molded piece.

30. The method as recited in claim 29 comprising providing said protein in an amount of from 2 to 20% by weight based on the total weight of said compression powder.

31. The method as recited in claim 6 further comprising in step a) mixing said plurality of pieces with a fiber to form a compression powder and step b) comprises placing said compression powder into said mold and compression molding said powder to form said molded piece.

32. The method as recited in claim 31 comprising providing said fiber in an amount of from 2 to 50% by weight based on the total weight of said compression powder.

33. The method as recited in claim 1 wherein step b) comprises compressing said at least one dried aerated confection piece by from 10 to 50% to form said molded piece.

34. The method as recited in claim 1 wherein said compression mold is maintained at a temperature of from 50 to 120° F.

35. The method as recited in claim 1 wherein said compression mold is maintained at a temperature of from 70 to 90° F.

36. A compression molded dried aerated confection having therein a plurality of air cells.

37. The compression molded aerated confection of claim 36 having a moisture of from 1 to 5%.

38. The compression molded aerated confection of claim 36 having a sufficient buoyancy to float on water.

39. The compression molded aerated confection of claim 36 comprising at least one vitamin, or at least one mineral, or a mixture thereof.

40. The compression molded aerated confection of claim 36 comprising dehydrated marshmallow.

41. The compression molded aerated confection of claim 36 comprising dried meringue.

42. The compression molded aerated confection of claim 36 comprising a dye in an amount of from 0.01 to 2% by weight based on the weight of said confection.

43. The compression molded aerated confection of claim 36 comprising a flavor in an amount of from 0.01 to 2% by weight based on the weight of said confection.

44. The compression molded aerated confection of claim 36 comprising a filler in an amount of from 10 to 30% by weight based on the weight of said confection.

45. The compression molded aerated confection of claim 36 comprising a dextrose.

46. The compression molded aerated confection of claim 45 comprising dextrose present in an amount of from 10 to 30% by weight based on the weight of said confection.

47. The compression molded aerated confection of claim 36 comprising a fruit powder in an amount of from 5 to 15% by weight based on the weight of said confection.

48. The compression molded aerated confection of claim 47 wherein said fruit powder comprises at least one of a freeze dried fruit, a spray dried fruit, a drum dried fruit, a ground fruit, or a mixture thereof.

49. The compression molded aerated confection of claim 36 comprising from 5 to 20% by weight of a flour based on the total weight of said confection.

50. The compression molded aerated confection of claim 36 comprising from 10 to 50% by weight of a cereal based on the total weight of said confection.

51. The compression molded aerated confection of claim 50 wherein said cereal comprises a ready to eat cereal, a cereal grain, or a mixture thereof.

52. The compression molded aerated confection of claim 36 comprising an edible lubricant, an emulsifier, an anti-caking agent, or a mixture thereof.

53. The compression molded aerated confection of claim 52 wherein at least one of said edible lubricant, said emulsifier, or said anti-caking agent are present in an amount of 0.5 to 2% by weight based on the total weight of said confection.

54. The compression molded aerated confection of claim 36 comprising from 0.5 to 2% by weight of magnesium stearate based on the total weight of said confection.

55. The compression molded aerated confection of claim 36 comprising from 10 to 20% by weight of cookie pieces based on the total weight of said confection.

56. The compression molded aerated confection of claim 36 comprising from 2 to 20% by weight of protein based on the total weight of said confection.

57. The compression molded aerated confection of claim 36 comprising from 2 to 50% by weight of fiber based on the total weight of said confection.

58. The compression molded aerated confection of claim 36 comprising a dye, said molded confection having a first color when dry and a second color upon exposure to a wet liquid, said second color different from said first color.
